(19) United States
(12) Patent Application Publication
(10) Pub. No.: US 2008/0223406 A1
(43) Pub. Date: Sep. 18, 2008

(54) Carbon Dioxide Cleaning Method

(75) Inventors: Kenneth Lindqvist, Skarpnaeck (SE); Anders Marcusson, Lidingoe (SE); Joachim Karthaeuser, Sollentuna (SE); Jan Hamrefors, Taeby (SE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/632,988

(22) PCT Filed: Jul. 12, 2005
(86) PCT No.: PCT/EP05/07558

§ 371 Date: Dec. 12, 2007

(30) Foreign Application Priority Data
Jul. 22, 2004 (EP) 04017401.3

(51) Int. Cl. B08B 7/00; D06F 43/00; B08B 3/12

(52) U.S. Cl. 134/21; 134/22.18; 8/142

(57) ABSTRACT

A method for cleaning objects is disclosed. The method includes placing the objects into a cleaning chamber and contacting them with a dense phase gas. After draining the dense phase gas from the cleaning chamber, the pressure in the cleaning chamber is changed at a rate of at least 1 bar per minute, preferably at a rate of 5 bar per minute, more preferably at a rate of 10 bar per minute.

This application claims the priority of International Application No. PCT/EP2005/007558, filed Jul. 12, 2005, and European Patent Document No. EP 04017401.3, filed Jul. 22, 2004, the disclosures of which are expressly incorporated by reference herein.

### BACKGROUND AND SUMMARY OF THE INVENTION

The invention relates to a method for cleaning objects comprising the steps of placing the objects into a cleaning chamber, contacting the objects with a dense phase gas, and draining the dense phase gas from the cleaning chamber.

Dry-cleaning using liquid carbon dioxide is known as an environmentally friendly cleaning technique with favorable cleaning properties, which can be used to remove contaminants from garments or textiles as well as from metal, machinery, workpieces or other parts.

A combination of liquid carbon dioxide with additives like surfactants affords a satisfactory removal of soluble contaminants, but only unsatisfactory removal of particles like fibers and particulate contaminants such as dried food or textiles.

In order to improve the cleaning efficiency U.S. Pat. No. 5,337,446 proposes to additionally apply ultrasonic energy during cleaning in liquid or supercritical carbon dioxide. The application of sonic energy shall particularly improve the removal of sub-micron particulates.

International patent application WO 01/49920 describes a method for cleaning porous materials like textiles in liquid carbon dioxide which by rapid, intermittent pressure drops is brought into boiling. During the boiling of the carbon dioxide steam bubbles are created on the fibers of the textiles which is to be considered as a micro-mechanical treatment.

It is an object of the invention to provide a method for cleaning objects in a dense phase gas like carbon dioxide which facilitates and improves the removal of solid contaminants.

This object is achieved by a method for cleaning objects comprising the steps of placing the objects into a cleaning chamber, contacting the objects with a dense phase gas, and draining the dense phase gas from the cleaning chamber, wherein after the draining step the pressure in the cleaning chamber is changed at a rate of at least 1 bar per minute, preferably at a rate of 5 bar per minute, more preferably at a rate of 10 bar per minute.

In a traditional dense phase washing cycle the objects are placed into a cleaning chamber and washed in contact with a dense phase gas. Then the dense phase gas is drained from the cleaning chamber and passed to an intermediate storage tank. Hereby the pressure is normally maintained in the cleaning chamber.

The inventors have found that during cleaning in a dense phase gas a micro-mechanical treatment, such as disclosed in U.S. Pat. No. 5,337,446 or in WO 01/49920, may loosen the contact between the contaminant and the object, but it does not provide a satisfactory removal of the particulate contaminants from the complex surfaces of porous objects.

According to the invention an additional cleaning step is carried out. After the dense phase gas is drained from the cleaning chamber the pressure is rapidly changed. That is, first the liquid or super-critical phase of the gas is drained off the cleaning chamber and then the pressure of the remaining gaseous atmosphere within the cleaning chamber is rapidly changed. The invention thus creates a pressure gradient within the objects to be washed. The rapid pressure change leads to an outgassing of the objects. The gas sweeps undesired particulates out of the object. Any small contaminant particles can be blown out of a fabric or of thin holes in the objects which are cleaned. Further the mechanical detachment of particulate soil near the surface is facilitated.

It is assumed that the inventive method creates a pressure gradient within the objects and that this pressure gradient causes a transport of contaminants out of the objects. Consequently, the pressure change is carried out after the dense phase gas has drained off, that is the pressure is changed when the cleaning chamber essentially contains no more gas in its dense phase but only in its gaseous phase.

### DETAILED DESCRIPTION OF THE EXEMPLARY EMBODIMENTS

In a preferred embodiment the objects to be cleaned are totally soaked with the dense phase gas prior to starting the draining step, that is, essentially all pores of the objects are filled with dense phase gas. When the inventive pressure change is carried out, both a gas stream and a liquid stream flow out of the object.

In order to fill-up the object with as much dense phase gas as possible it is preferred to use the following procedure: The cleaning chamber is filled with the dense phase gas. The objects within the cleaning chamber are rotated very slowly in order to not create too many gas bubbles in the cleaning chamber, but also to mechanically force the gas out of the object. Rotation also improves the overall cleaning result.

The pressure in the cleaning chamber is then continuously increased by for example a compressor or by an over pressure in other parts of the cleaning system. The dense phase gas in the cleaning chamber will then be sub-cooled to some degree, which supports the fill-up of the objects with the dense phase gas. The dense phase gas will then clean the internal surface of the objects and later on, when the pressure is decreased, the mixture of dense phase gas and gas will transfer particles and dirt up to the surface.

It is assumed that at present cleaning methods the gas bubbles stay too long at one specific spot which results in a low cleaning uniformity. Therefore, it is preferred to change the rotation of the objects in the cleaning chamber between slow rotation, for example less than 45 rpm, to fast rotation, for example more than 45 rpm, preferably more than 70 rpm. Thereby, a more stable and higher flow of dense phase gas to the objects is achieved and a faster total fill-up of dense phase gas into the objects. The dense phase gas is flowing into the objects and gas is going out of the objects in direction to the center of the cleaning chamber. This will also improve the uniformity of the cleaning procedure over all parts of the objects.

Even if a lot of particulate contaminants are transferred out of the objects and into the dense phase gas, the contaminants could still deposit back on the objects. It has been found advantageous to slowly rotate the objects and at the same time start draining of the dense phase gas from the cleaning chamber when the pressure in the cleaning chamber is decreased. When most of the dense phase gas is drained out from the cleaning chamber, then the objects should be additionally drained by high-speed rotation. This procedure could be repeated several times.

It is also possible to circulate the dense phase gas from the cleaning chamber through a filter and then back to the cleaning chamber. This could for example be done by a pump or, in case the cleaning chamber is provided with a rotatable drum, the rotation of the drum could create a flow of dense phase gas.

As already mentioned the invention is based on the discovery of the positive cleaning effect of a pressure gradient between the objects to be cleaned and the surrounding atmosphere. In order to achieve the advantages of the invention the pressure should be changed at a rate of at least 1 bar per minute, preferably at a rate of 5 bar per minute, and more preferred at a rate of 10 bar per minute.

According to a preferred embodiment the pressure is decreased during the pressure change step. It is also possible to increase the pressure by adding the dense phase gas in gaseous form or by addition of another gas. For example, in case carbon dioxide is used as the dense phase gas it has been found advantageous to add helium, nitrogen or air. That increase in pressure is preferably practiced at a rate of at least 1 bar per minute, preferably at a rate of 5 bar per minute, and more preferred at a rate of 10 bar per minute. But it is also possible that after the draining step the pressure is increased by addition of a second gas and then the rapid inventive pressure drop is carried out. In that case the rate of the prior increase in pressure has not necessarily fulfilled the above mentioned rate of at least 1 bar per minute.

It is preferred to carry out more than one washing cycle after the objects have been placed in the cleaning chamber. In that respect a washing cycle comprises the following steps:

1. The cleaning chamber is at least partly filled with the dense phase gas.
2. The objects are washed in contact with the dense phase gas.
3. The dense phase gas is drained from the cleaning chamber.
Finally the clean objects are unloaded from the cleaning chamber.

This sequence of steps 1 to 3 may be repeated one or several times with the inventive pressure change being carried out between any two of these washing cycles. For example, the objects are first pre-washed according to steps 1 to 3 and then a main washing cycle follows. The inventive pressure change would then be applied between the pre-washing and the main washing cycle and/or after the main washing cycle.

The preferred dense phase gas is liquid carbon dioxide. The objects are preferably contacted with the dense phase gas, especially with liquid carbon dioxide, at a pressure between 30 and 60 bar, particularly at a pressure between 35 and 55 bar.

During the pressure change the pressure is preferably changed by more than 25%, more preferred by more than 50%. For example, when using liquid carbon dioxide as cleaning medium at a pressure of 40 bar, the pressure is rapidly decreased to 30 bar or more preferred to 20 bar between two washing cycles. Then the next washing cycle starts, that is new liquid carbon dioxide is filled into the cleaning chamber. After the last washing cycle the pressure may be rapidly reduced to 20 bar according to the invention. The final pressure drop to atmospheric pressure can be practiced as usual.

The cleaning efficiency is further improved by rotating or moving the objects during the inventive pressure change. For that reason the cleaning chamber is preferably provided with a rotatable basket where the objects are placed. It is further advantageous to vary the speed and direction of the rotation.

It is further preferred to transfer gas between the cleaning chamber and a gas storage tank or a still during the pressure change. In case the pressure is rapidly decreased gas is transferred from the cleaning chamber to a gas storage tank or into the still for later use, for example to pressurize the cleaning chamber during another washing cycle. It is also possible to use the gas from the gas storage tank for another application, for example for inerting purposes.

The invention provides a cleaning method with increased penetration depth which allows for removal of particulate contaminants from bulky and porous objects. Thus the invention is in particular useful for cleaning textiles and especially for cleaning mattresses, pillows, blankets and the like.

Small organisms like bacteria or insects stuck to the objects to be cleaned are killed during the washing cycle. But by conventional carbon dioxide cleaning the residues of the bacteria and insects are not satisfactorily removed from the objects. WO 01/49920 and U.S. Pat. No. 5,337,446, both mentioned in the introductory part of this specification, teach an additional micro-mechanical treatment during the cleaning operation in order to detach such residues and particulates from the objects.

However, it has been found that these methods are not suitable for cleaning large porous objects like mattresses, pillows and blankets, since these objects work as a filter when the dense phase gas is drained from the cleaning chamber. Thus, any particulate which has already been detached from the object is filtered out of the dense phase gas and sticks again to the surface of the object.

Without wishing to be bound by any theory it is assumed that according to the invention the residues are not washed into the dense phase gas, but blown out of the object into the gas atmosphere within the cleaning chamber and can then be removed with the gas atmosphere. The particulates do not re-stick to the objects.

Therefore, a preferred application of the invention is the removal of micro-organisms, residues of micro-organisms, insects and allergenic substances from mattresses, pillows, garments and textiles as well as soft toys. For example, the invention provides an effective method to remove mites, residues of mites and allergens from blankets, bed sheets and so on. This is in particular of interest for people suffering from an allergy.

The invention further provides an improved method for cleaning industrial parts, for example, injection molded plastic parts, from particles like fibers, sintered metal, silicates, dust and so on.

1-12. (canceled)

13. A method for cleaning objects, comprising the steps of:
placing an object into a cleaning chamber;
contacting the object with a dense phase gas;
draining the dense phase gas from the cleaning chamber; and
after draining the dense phase gas from the cleaning chamber, changing a pressure in the cleaning chamber at a rate of at least 1 bar per minute.

14. The method according to claim 13, wherein the pressure is changed at a rate of 5 bar per minute.

15. The method according to claim 13, wherein the pressure is changed at a rate of 10 bar per minute.

16. The method according to claim 13, wherein the pressure in the cleaning chamber is changed by reducing the pressure.

17. The method according to claim 13, wherein after the step of changing the pressure in the cleaning chamber, the object is again contacted with a dense phase gas.

18. The method according to claim 13, wherein the dense phase gas is liquid carbon dioxide.

19. The method according to claim 13, further comprising the step of rotating the object during the step of changing the pressure.

20. The method according to claim 13, wherein during the step of changing the pressure, a gas is transferred between the cleaning chamber and a gas storage tank or between the cleaning chamber and a still.

21. The method according to claim 13, wherein the object is contacted with the dense phase gas at a pressure between 30 and 60 bar.

22. The method according to claim 21, wherein the object is contacted with the dense phase gas at a pressure between 35 and 55 bar.

23. The method according to claim 13, wherein the pressure is changed by more than 25%.

24. The method according to claim 23, wherein the pressure is changed by more than 50%.

25. The method according to claim 13, wherein the object is a textile, a mattress, or a pillow.

26. The method according to claim 13, wherein the object is a metal or plastic industrial part.

27. The method according to claim 13, wherein the step of changing the pressure removes a micro-organism, insect, or allergenic substance from the object.

28. The method according to claim 13, wherein the object is completely soaked with the dense phase gas.

29. The method according to claim 13, wherein the pressure in the cleaning chamber is changed by increasing the pressure.

30. The method according to claim 29, wherein the pressure is increased by adding the dense phase gas in a gaseous form to the cleaning chamber.

31. The method according to claim 29, wherein the pressure is increased by adding a gas to the cleaning chamber.

32. The method according to claim 13, wherein the pressure in the cleaning chamber is changed at a rate of at least 1 bar per minute to a pressure above an atmospheric pressure.
